(19) United States
(12) Patent Application Publication
(10) Pub. No.: US 2009/0315322 A1
(43) Pub. Date: Dec. 24, 2009

(54) Fire Engine Hose Connector

(76) Inventor: Eric Topacio, San Diego, CA (US)

Correspondence Address: LAW OFFICE OF MARK WISNOSKY, 3200 Fourth Avenue, Suite 201, SAN DIEGO, CA, 92103, US

(21) Appl. No.: 12/142,687

(22) Filed: Jun. 19, 2008

(51) Int. Cl. F16L 37/00

(52) U.S. Cl. 285/33; 285/62

(57) ABSTRACT

A fire engine hose connector system and a method for using the system are reported. The system allows for rapid connection between the fire hose and the fire engine, and more importantly the system enables even more rapid disconnection. The fire engine and fire fighting personnel may make a rapid escape form an overtaking wildfire. The ability to rapidly disconnect and escape from the fire scene allows the fire engine and personnel to access hydrant supplies that would otherwise not be available due to safety procedures that preclude connection when the long disconnect time requirements of prior art connectors place the escape of the fire engine and personnel at risk in a rapidly moving fire.

### BACKGROUND OF THE INVENTION

1. Technical Field

The present invention relates to a quick disconnect connector useful for connecting a fire engine to a fire hydrant.

2. Related Background Art

Brush fires are common throughout the southwestern United States as well as many other parts of the world. Often driven by strong desert winds these fires can consume thousands of acres of brush and destroy homes and other buildings in there paths. Winds in Santa Ana conditions in portions of Southern California can often reach 50 mile per hour and even higher in gusts. The shifting direction of these winds, especially on a local scale can result in unpredictable and rapidly changing direction for the driven fires. These winds drive the fires at such velocity that fire fighters are often in danger of being overrun by the fire they are on the ground to fight. The fires are fought with aerial drops of water and fire retardant, earth moving equipment and other mechanized means. However the primary weapon against these fires is still the firefighting crew on the ground using hand tools to create firebreaks and conventional fire pumper engines and water to dowse the blaze. The priority is often to provide sufficient water on the fire or on homes in the path of the fire. These wildfires are not confined to remote forests or scrubland. Fires regularly erupt in populated areas. In these cases the availability of fire hydrants as a supply of water can be a great aid and lifesaver for the fire fighting crew. Otherwise the water supply of the ground crew is limited to what can be carried in the tank of a fire engine, typically 500 gallons. However, even when available the fire hydrants are not always used. The fire fighting crew must be ready to evacuate an area if the fire shifts or is simply overwhelmingly large and fast moving. The evacuation of an area must often be done very quickly. There is often not time to disconnect fire hoses from supply hydrants. This evacuation safety requirement often precludes connecting to a hydrant supply even when they are available. The time required to return to the hydrant, turn off the flow and disconnect the hose at least from the engine may be too long and cost lives. Safety procedures to ensure the safety of the fire fighting crew dictated by the restrictions of heretofore available equipment mean that fires are often fought just with the water that can be carried on the fire engine even when a hydrant supply is available. A means is needed to easily and rapidly connect and just as importantly disconnect a fire hose connection between a hydrant and a fire engine water supply inlet.

There have been improvements that address connections to a fire hydrant or to a fire engine but do not provide a solution to the problem of rapid disconnect without returning to the hydrant to stop the flow. The connection of a fire hose to a hydrant is facilitated by quick connect fittings such as the Storz fitting described in U.S. Pat. No. 489,107. However this fitting allows just a rapid mechanical connection of the hose to the hydrant but does not address the issue of water flow. A Storz or similar fitting can also rapidly connect and disconnect from the fire engine. However the hose cannot be connected or disconnected to the hydrant with the hydrant turned on. Disconnecting the hose at the engine with the hose under pressure is not possible with current equipment. U.S. Pat. No. 6,447,027 similarly addresses he issue of rapidly connecting a hose to a fire hydrant. This invention also does not address the issue of rapidly disconnecting the hose. Other inventions such as U.S. Pat. No. 7,255,131 address aspects of connections to the fire hose but again do not solve the problem of rapidly disconnecting a hose from a fire engine. There is a need for a rapid hose connection that can be easily and rapidly attached to and detached from a fire engine without the requirement of returning to the hydrant to turn off the flow.

### DISCLOSURE OF THE INVENTION

The invention comprises a quick connect fitting adapted at one end to fit to the standard connection on a fire engine water supply inlet and adapted at the other end to fit the standard connections of a fire hose. Typically the fire hose connection is a 4-inch connection and the fire engine connection is also a 4-inch connection, but these do not represent any size constraint on the invention. Other size connections for different hose and fire engine fittings can equally well be practiced under the invention. The quick connect portion of the fitting consists of a coupler such as that marketed under the brand name of PT Coupling Company of Enid Oklahoma, USA. The quick coupling consists of both a quick disconnect link that may be connected and disconnected with flow stopped when disconnected and an integral gate valve to turn off the supply when making connections. The gate valve is used in those situations where the size of the hose and fittings and the supply pressure preclude making or breaking connections under supply pressure with forces capable of being applied by hand.

Operation of the system includes attachment of a quick connect fitting with adapter to the fire engine water supply inlet fittings. A fire hose is attached to the hydrant using normal fittings known to those skilled in the art. The distal end of the fire hose is fit with an adapter that is then attached to the quick connect fitting consisting of the fitting and gate valve. The valve is in the closed position and the fitting is mated with the quick connect fitting and adapter on the fire engine inlet. The water supply at the hydrant is then turned on and the gate valve is opened. Water flows from the hydrant through the fitting into the engine manifold, storage and pumping system. Disconnecting the system in an emergency such as being quickly overrun by a wildfire requires simply shutting the valve and popping off the quick connect fitting. The hose may then be left under pressure and temporarily abandoned as the engine drives away from danger. Disconnection is rapid because there is no need to leave the immediate vicinity of the engine, no need to go to the hydrant and stop the flow and relieve the pressure prior to disconnecting the hose at the engine.

### BRIEF DESCRIPTION OF THE DRAWINGS

The novel features characteristic of the invention are set forth in the claims. The invention itself however as we all as the preferred mode of use, and further objects and advantages thereof, will best be understood by reference to the following detailed description of an illustrative embodiment when read in conjunction with the following drawings. Same features are numbered consistently throughout.

FIG. 1 shows the invention connected between a supply hose and the supply inlet of a fire engine.

FIG. 2 shows the invention disconnected from the fire engine.

FIG. 3 shows an exploded view detailed embodiment of the invention.

FIG. 4 shows a detailed view of an embodiment of the invention.

### MODES FOR CARRYING OUT THE INVENTION

A connector and method of use that allows rapid connection, and in some cases more importantly, disconnection of a fire hose supply line between a hydrant and a fire engine is described. The connector allows rapid connection for quick set up and in an emergency may be disconnected from the engine to allow it to drive away without the need to return to the hydrant to shut off the supply or drain the fire hose.

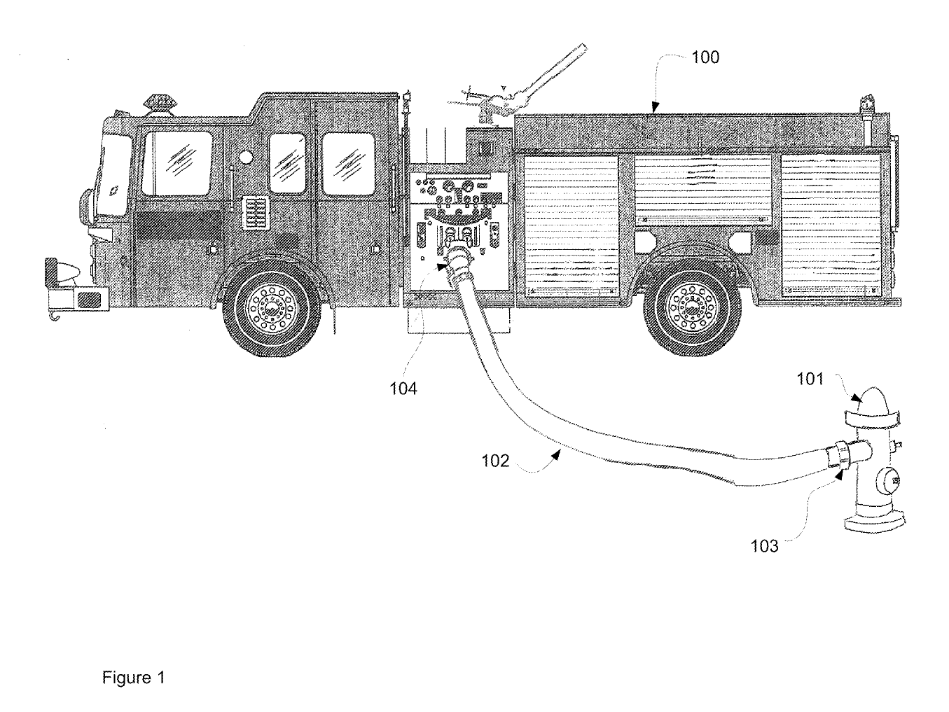

Referring to FIG. 1, a fire engine 100 is attached to a hydrant 101 to provide a supply of water to the manifold, pumps and holding tanks of a typical fire engine. The conduit for the supply is typically a 4-inch fire hose 102. At the hydrant end the connection is made through a Storz connector 103 or similarly threaded connector and adapter to attach the hose to the hydrant as is known in the art. The non-hydrant end of the hose is attached to an adapter 104 embodiment of the invention that allows connection of the hose to the fire engine using a quick disc-connect fitting. FIG. 1 shows the connector with the hose attached to the engine.

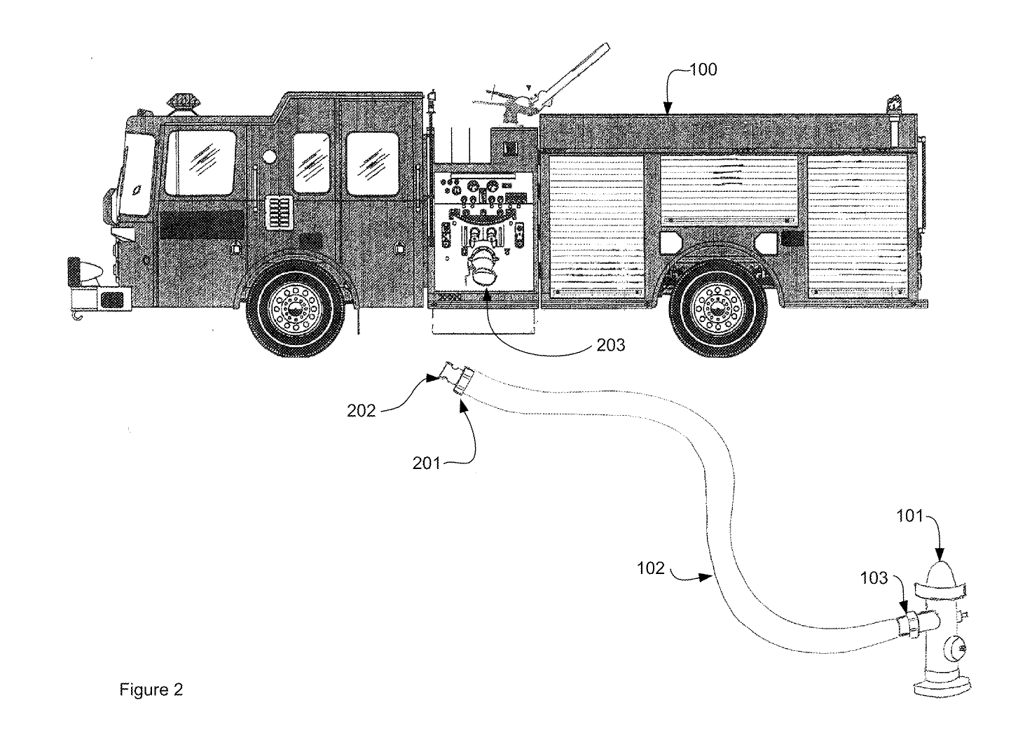

FIG. 2 shows the connector embodiment of FIG. 1 with the connector disconnected from the engine, as would be the case prior to making the initial connection or in the case of disconnecting from the hydrant supply to enable rapid evacuation of the engine and crew. The fire hose 102 is connected to the hydrant 101 via a connector 103 such as a Storz connector or other equivalents know in the art. The distal end of the fire hose is connected to an adapter 201 that is connected in turn to one half of a quick—connect connector 202. Since the connector 202 is disconnected from the mating half 203, attached to the engine, a spring loaded valve within the connector 202 is actuated to prevent flow. If the hydrant 101 is in an on state the hose 102 will be charged with water at the hydrant pressure but no water will flow. The remaining connector parts 203 may remain attached to the engine during a rapid evacuation procedure. Another embodiment shown in FIG. 2 comprises a fire engine 100 with an adapter 203 fit to accommodate quick connect hose couplings 202.

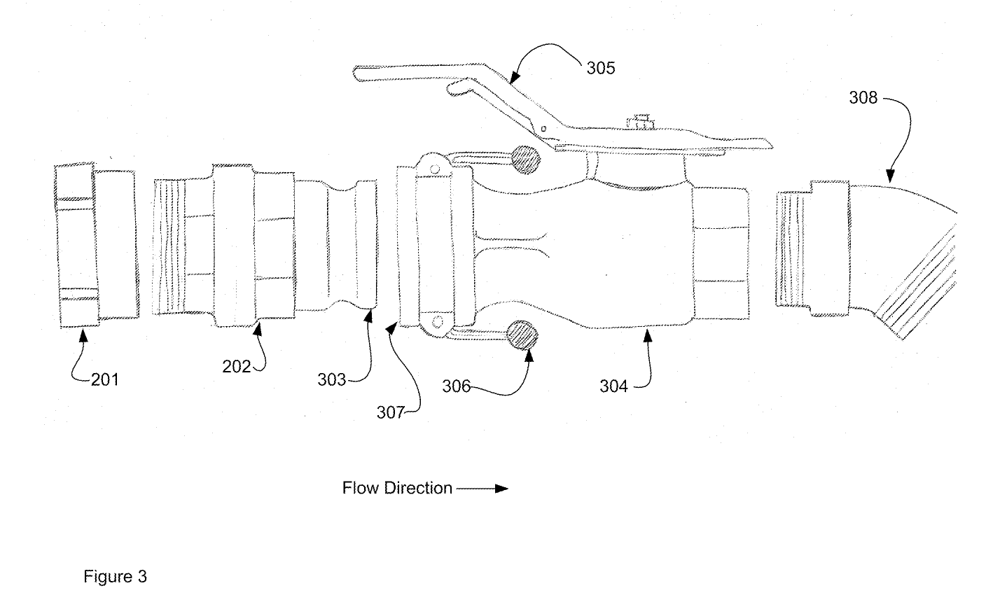

FIG. 3 shows a closer exploded view of an embodiment the connector. The connector consists of two groups of fittings. The first group, 201, 202, consists of a swivel adapter 201, sized to fit to standard fittings on fire hoses. The second fitting 202 includes a first end adapted to fit the swivel adapter 201 and a second end 303, one half of a quick connect fitting 303. In the preferred embodiment the one half of a quick connect fitting 303 is the male half of such fittings. The interior of the quick connect fitting 202, not shown, is fitted with a spring loaded valve such that water cannot flow in the intended direction shown unless the fitting is mated with a corresponding second half of a quick connect fitting. The second group consists of two fittings. The first 304 includes a mating quick connect fitting 307 that mates with the fitting 303 of the first group and in doing so releases the integrated spring valve incorporated into the first group fitting 303 and thereby enabling flow. The second group further comprises a latching mechanism activated by handles 306 to ensure secure connection of the fittings 303 and 307 especially when the assembly is under pressure. In one embodiment a gate valve activated by lever 305 is further integrated into the second group fitting 304 to allow control of the flow when a hose is connected and the spring valve of the first group fitting 202 is released. Another embodiment consists of an angled adapter 308 that is sized and threaded for attachment to a fire engine standard inlet fitting. The fitting 308 is angled such that when connected to a fire engine inlet manifold and thereby elevated above the ground, a smooth connection to the hose is enabled without a sharp bend or kink. In a preferred embodiment the bend is 150 degrees. The fitting would be known in the art as a 30-degree elbow.

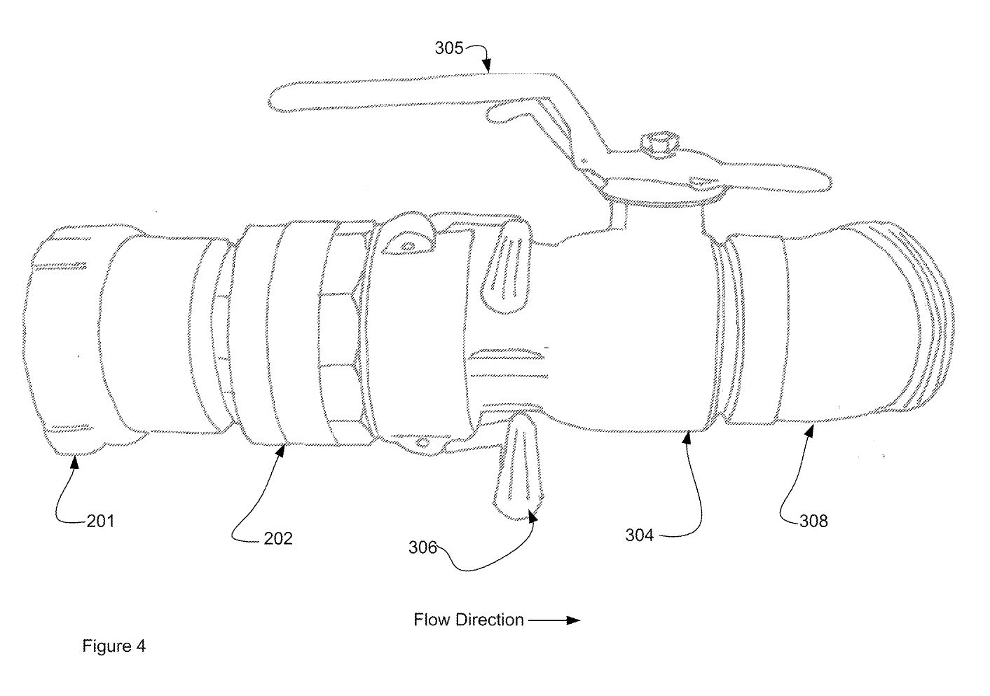

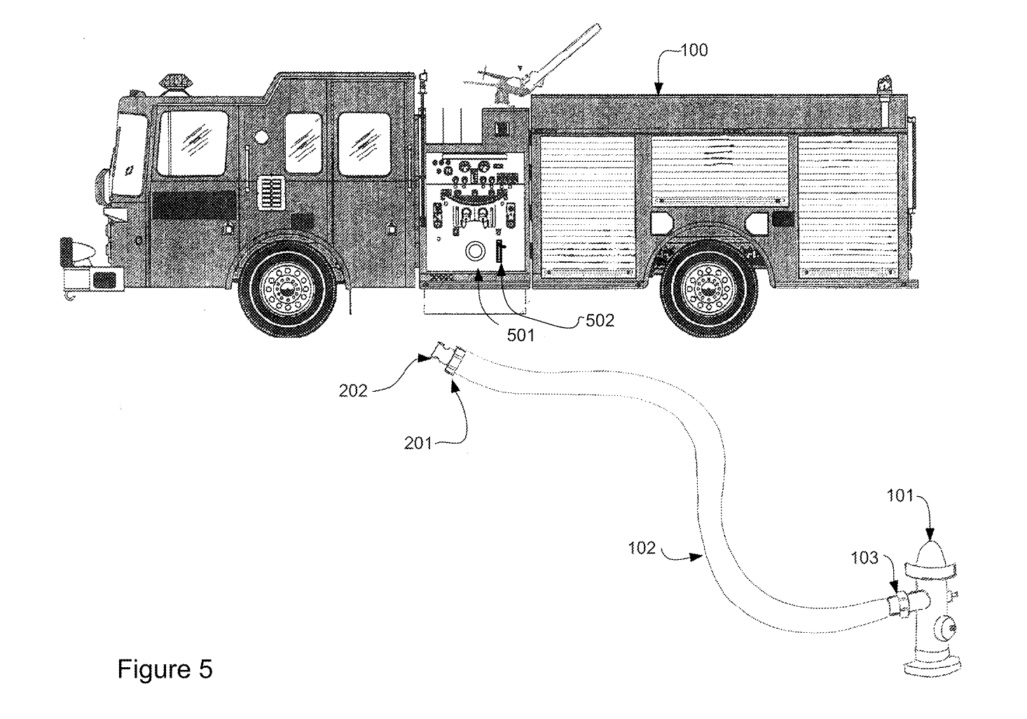

FIG. 4 depicts the fitting of Figure with the parts in mated condition. A swivel connector 201 is attached to the male portion of a quick connect fitting 202. This male fitting mates with the corresponding female fitting 304. The quick-disconnect fitting 202 includes a spring-loaded valve that prevents flow until it is mated with the corresponding female fitting 304. In another embodiment the fitting 304 further includes a latching mechanism activated through levers 306. In another embodiment especially useful for large fittings and high water pressures the fitting further includes a gate valve activated by lever 305. The fitting 304 is connected to the fire engine water input supply via an adapter 308. In another embodiment the adapter 308 is angled to reduce stress on the fittings when attached to a hose under pressure. In a preferred embodiment the adapter 308 is a 30-degree elbow.

In another embodiment shown in FIG. 5, the receiving end of the connector 307 and the associated fittings and features 304, 305, 306, 307, 308 are integrated 501 into the manifold and valve structure of the engine. Release levers and gate valves would be controlled through integrated levers 502. In this embodiment, adapters would not be needed on the engine side and the engine receiving fitting would fit with the connector 202 on the hose through the male portion of a quick connect fitting 303. This embodiment eliminates the need for special adapters to be attached both to the engine and the hose. Another embodiment shown in FIG. 5 comprises a fire engine fit with integrated fittings 501 to accommodate quick connect hose fittings 202.

Another embodiment includes the method of using a quick connect hose fitting to a fire engine. Referring to FIG. 2, a fire engine 100 arrives at the scene of a fire and the fire personnel attach fitting adapter 203 to the fire engine. Fire hose 102 is unrolled and fitting 202 is mated with fitting 203 on the fire engine. The opposite end of fire hose 102 is attached to a hydrant 101 through one of various fittings 103 known in the art. The hydrant 101 is then activated through turning the appropriate valve on the hydrant thus supplying water through the hose 102 to the fire engine 100. Valves on the fitting 203 and incorporated into the fire engine 100 may be turned to initiate flow. Should the fire engine need to make a rapid retreat from the fire zone the fitting 202 is detached from the 203 and the fire engine may drive away. Because the fitting 202 incorporates spring loaded valves the hose 102 will remain charged with water but there will be no flow. The hydrant may be left in an on position and the hose 102 left behind to facilitate a rapid departure. It should be noted that the drawings shown are not to scale and the distance from the fire engine 100 to the hydrant 101 may be a considerable distance. The length of hose 102 may be such that it could not be rapidly recovered in an emergency retreat situation. The invention enables rapid connection and even more rapid disconnection. This is especially important in a firestorm situation where the fire engine and personnel may need to make a rapid escape from the fire scene.

Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

### SUMMARY

A fire engine hose connector system and a method for using the system are reported. The system allows for rapid connection between the fire hose and the fire engine, and more importantly the system enables even more rapid disconnection. The fire engine and fire fighting personnel may make a rapid escape form an overtaking wildfire. The ability to rapidly disconnect and escape from the fire scene allows the fire engine and personnel to access hydrant supplies that would otherwise not be available due to safety procedures that preclude connection when the long disconnect time requirements of prior art connectors place the escape of the fire engine and personnel at risk in a rapidly moving fire.

What is claimed is:

1. A fire engine hose connector system comprising:
a) fire hose having a connector at a first end for attachment to a fire hydrant and a connector at a second end for attachment to a fire engine supply input said connector at the second end comprising a swivel connector and a first quick connect connector, and
b) an adapter for attachment to the fire engine supply input, said adapter comprising a threaded elbow adapter fitted at one end to attach to the fire engine and fitted at the other end to attach to a second quick connect connector, said second quick connect connector being a mate for said first quick connect connector.

2. The connector system of claim 1 further comprising a gate valve incorporated in the second quick connect connector.

3. The connector system of claim 1 where the first quick connect connector is a male fitting and the second quick connect connector is a female fitting.

4. The connector system of claim 1 where the elbow adapter is a 30-degree elbow.

5. The connector system of claim 1 wherein the adapter for attachment to the fire engine supply unit is integrated into the fire engine.

6. A fire engine having a hose connector system comprising:
a) fire hose having a connector at a first end for attachment to a fire hydrant and a connector at a second end for attachment to a fire engine supply input said connector at the second end comprising a swivel connector and a first quick connect connector, and
b) an adapter for attachment to the fire engine supply input, said adapter comprising a second quick connect connector, said second quick connect connector being a mate for said first quick connect connector.

7. The fire engine of claim 6 further comprising a gate valve incorporated in the second quick connect connector.

8. The fire engine of claim 6 where the first quick connect connector is a male fitting and the second quick connect connector is a female fitting.

9. The fire engine of claim 6 wherein the adapter for attachment to the fire engine supply unit is integrated into the fire engine.

10. A method of connecting a fire hose to a fire engine said method comprising:
a) attaching a first quick connect connector to the fire engine supply input,
b) attaching a fire hose to the first quick connect connector using a second quick connect connector, said first and second quick connect connectors comprising a mating set, and said second quick connect connector attached to the fire hose with a swivel connector, and
c) attaching the second end of the fire hose to a fire hydrant discharge port.

11. The method of claim 10 wherein the first connector is a female connector and the second connector is a male connector.
